(19) United States
(12) Patent Application Publication
(10) Pub. No.: US 2025/0102091 A1
(43) Pub. Date: Mar. 27, 2025

(54) CONNECTOR AND A CLEANING HOSE USING IT

(71) Applicant: Wenbo Zhang, Taizhou (CN)

(72) Inventor: Wenbo Zhang, Taizhou (CN)

(21) Appl. No.: 18/372,110

(22) Filed: Sep. 24, 2023

(51) Int. Cl. F16L 37/23; F16L 33/32

(52) U.S. Cl. CPC F16L 37/23; F16L 33/32

(57) ABSTRACT

A connector, comprising a first connection block, a second connection block, and a third connection block, the first connection block is composed of a first connection end and a second connection end, the first connection end has a cylindrical surface, and multiple round holes are evenly arranged around the first connection end, the round holes are embedded with card receiving balls, the inner surface of the first connection end is evenly arranged with multiple card slots, an elastic component is also set on the outer surface of the first connection end, the third connection block includes a plug-in part and a third connection end, the plug-in part has a cylindrical surface, and its outer surface is evenly arranged with multiple cards blocks and multiple grooves, the second connection block is movably sleeved on the outer circumference of the first connection block through the elastic component.

### TECHNICAL FIELD

The present invention relates to the technical field of cleaning accessories, in particular to a connector for a cleaning hose.

### BACKGROUND

In daily life, a large amount of cooking fumes is produced during the cooking or burning process. The generation of cooking fumes is due to the incomplete combustion of oil substances depositing fine and loose black soot. Cooking fumes often adhere to the chimney, and when we clean the chimney, an extended cleaning tool is needed. At present, traditional cleaning hoses used daily include multiple hose bodies, which are interconnected, but after connection, relative rotation easily occurs between the hose bodies. At the same time, the connection method of the hose bodies is relatively complex and cannot be applied to various scenarios, making it inconvenient for people to operate when using cleaning hose.

Chinese patent No. 215382094 discloses a connector with good fixing effect for a telescopic rod. The telescopic rod is connected to the connector through threads, and the connector is connected to the brush through a plug-in method, thus making the overall connection stable. However, this connection method allows the connector to be connected to only one telescopic rod. The telescopic length of the telescopic rod is limited and cannot be applied in some occasions. Moreover, the telescopic structure of the telescopic rod is prone to loosening, which makes it inconvenient for users to operate when using the telescopic rod.

In view of the above problems, this invention application provides a new cleaning hose connector. This connector can connect multiple hoses through the connector, and after multiple hoses are connected, they are not prone to relative rotation. The connection of multiple hoses can be applied to various occasions. Moreover, this connector makes it convenient and quick to install cleaning hoses, thereby further enhancing user experience.

### SUMMARY

The present invention provides a connector, comprising:
A first connection block, a second connection block, and a third connection block, wherein
The first connection block is composed of a first connection end and a second connection end, the first connection end has a cylindrical surface, and multiple round holes are evenly arranged around the first connection end, the round holes are embedded with card receiving balls, the inner surface of the first connection end is evenly arranged with multiple card slots, an elastic component is also set on the outer surface of the first connection end; and
The third connection block includes a plug-in part and a third connection end, the plug-in part has a cylindrical surface, and its outer surface is evenly arranged with multiple cards blocks and multiple grooves; and
The second connection block is movably sleeved on the outer circumference of the first connection block through the elastic component, the plug-in part of the third connection block is inserted and fixed inside the first connection block, the card blocks are fixed on the card slots, and the card receiving balls are fixed in cooperation with the grooves.

The present invention also provides a cleaning hose, comprising:
A connector and a hose component, wherein
The connector includes a first connection block, a second connection block, and a third connection block, where the first connection block is composed of a first connection end and a second connection end, where the first connection end has a cylindrical surface, and multiple round holes are evenly arranged around the first connection end, and the round holes are embedded with a card receiving ball, and multiple card slots are evenly arranged on the inner surface of the first connection end, where an elastic component is also set on the outer surface of the first connection end, the third connection block includes a plug-in part and a third connection end, where the plug-in part has a cylindrical surface, and multiple card blocks and multiple grooves are evenly arranged on the outer surface of the plug-in part, where the second connection block is movably sleeved on the outer circumference of the first connection block through the elastic component, and the plug-in part of the third connection block is inserted and fixed inside the first connection block, and the card block is fixed on the card slot, and the card receiving ball is fixed in cooperation with the groove; and
The hose component consists of a first hose and a second hose; and
Where one end of the first hose is fixed in the second connection end of the first connection block, and one end of the second hose is fixed in the third connection end of the third connection block.

The present invention also provides a method of using a cleaning hose, comprising:
A connector and a hose component, wherein
The connector includes a first connection block, a second connection block, and a third connection block, where the first connection block is composed of a first connection end and a second connection end, and the third connection block includes a plug-in part and a third connection end; and
The hose component is composed of a first hose and a second hose, and at least one end of one hose in the hose component is equipped with a cleaning head, which has multiple through holes; and
Wherein, when the cleaning hose needs to be assembled for use,
The second connection block is sleeved on the outside of the first connection block, the third connection block is connected and fixed to the first connection end of the first connection block through the plug-in part, and the second connection block is located between the first connection block and the third connection block, thus completing the assembly of the connector; and
One end of the first hose is fixed in the second connection end, and one end of the second hose is fixed in the third connection end of the third connection block, thus completing the assembly of the cleaning hose; and
The cleaning head of the hose component is assembled on one hose, and a cleaning tool is connected and fixed on the cleaning head, thus enabling cleaning.

### BRIEF DESCRIPTION OF DRAWINGS

In order to explain the technical scheme of this application more clearly, the drawings needed in the implementation will be briefly introduced below. Obviously, the drawings described below are only some implementations of this application. For those skilled in the art, other drawings can be obtained according to these drawings without creative work.

FIG. 1 is a schematic diagram of the connector in this invention application;

FIG. 2 is an exploded view of the connector in this invention application;

FIG. 3 is a schematic diagram of the first connection block in this invention application;

FIG. 4 is a schematic diagram of the second connection block in this invention application;

FIG. 5 is a schematic diagram of the third connection block in this invention application;

FIG. 6 is a schematic diagram of the cleaning hose in this invention application;

FIG. 7 is a schematic diagram of the hose component in this invention application;

FIG. 8 is a connection relation schematic diagram in this invention application;

FIG. 9 is a schematic diagram of the cleaning head in this invention application.

In the drawings:

1000, connector; 1100, first connection block; 1110, first connection end; 1111, round hole; 1112, card receiving ball; 1113, card slot; 1114, elastic component; 1115, limit slot; 1120, second connection end; 1140, chamfer structure; 1200, second connection block; 1300, third connection block; 1310, plug-in part; 1320, third connection end; 1311, card block; 1312, groove; 2000, cleaning hose; 2100, hose component; 2110, first hose; 2120, second hose; 2130, cleaning head; 2131, through hole.

### DESCRIPTION OF EMBODIMENTS

In describing the preferred embodiments, specific termi-nology will be resorted to for the sake of clarity. It is to be understood that each specific term includes all technical equivalents which operate in a similar manner to accomplish a similar purpose.

While various aspects and features of certain embodiments have been summarized above, the following detailed description illustrates a few exemplary embodiments in further detail to enable one skilled in the art to practice such embodiments. Reference will now be made in detail to embodiments of the inventive concept, examples of which are illustrated in the accompanying drawings. The accompanying drawings are not necessarily drawn to scale. The described examples are provided for illustrative purposes and are not intended to limit the scope of the invention. It should be understood, however, that persons having ordinary skill in the art may practice the inventive concept without these specific details.

It will be understood that, although the terms first, second, etc. may be used herein to describe various elements, these elements should not be limited by these terms. These terms are only used to distinguish one element from another. For example, a first attachment could be termed a second attachment, and, similarly, a second attachment could be termed a first attachment, without departing from the scope of the inventive concept.

It will be understood that when an element or layer is referred to as being “on,” “coupled to,” or “connected to” another element or layer, it can be directly on, directly coupled to or directly connected to the other element or layer, or intervening elements or layers may be present. In contrast, when an element is referred to as being “directly on,” “directly coupled to,” or “directly connected to” another element or layer, there are no intervening elements or layers present. Like numbers refer to like elements throughout. As used herein, the term “and/or” includes any and all combinations of one or more of the associated listed items.

As used in the description of the inventive concept and the appended claims, the singular forms “a,” “an,” and “the” are intended to include the plural forms as well, unless the context clearly indicates other.

As a preferred embodiment of this invention, in order to allow multiple hoses to be connected through the connector, and to prevent relative rotation between the hoses after they are connected, this invention provides a connector 1000.

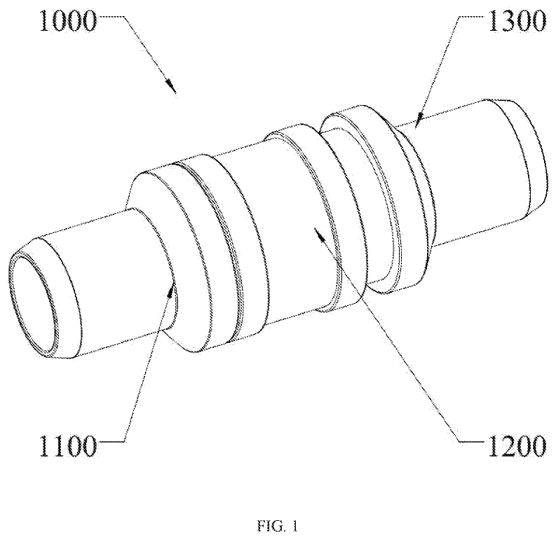

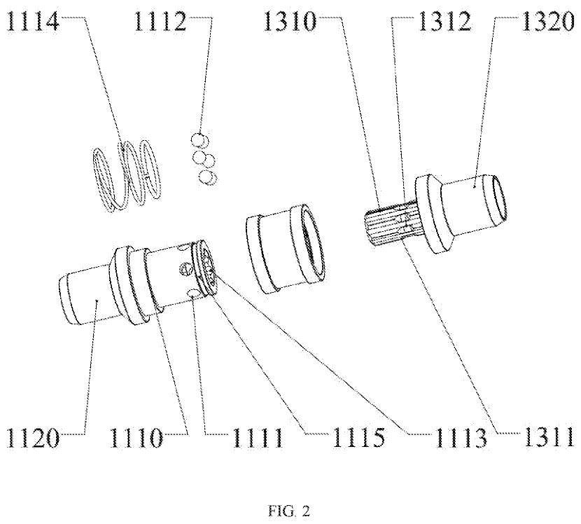

Refer to FIGS. 1 and 2, the connector 1000 includes a first connection block 1100, a second connection block 1200, and a third connection block 1300.

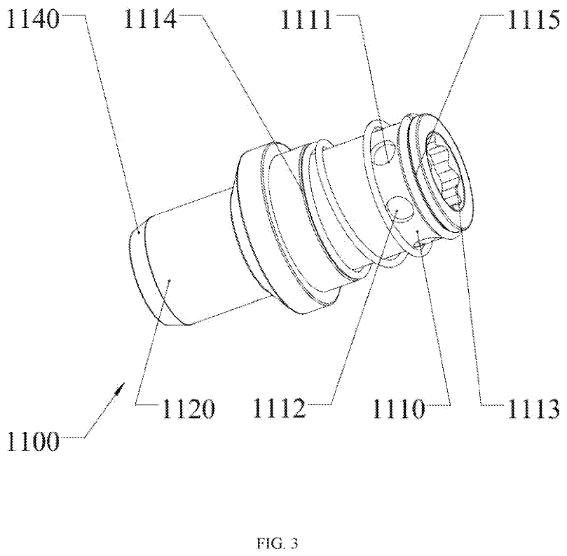

Refer to FIGS. 2 and 3, the first connection block 1100 is composed of a first connection end 1110 and a second connection end 1120. The first connection end 1110 is a cylindrical structure with an inner surface and an outer surface.

In some embodiments (not shown), the shape of the first connection end 1110 can also be rectangular, or square, or elliptical, or any other three-dimensional geometric shape, curved and irregular shape.

Refer to FIGS. 2 and 3, further, there are multiple round holes 1111 designed along the circumferential direction on the outer surface of the first connection end 1110, the round holes 1111 are evenly distributed on the first connection end 1110 and penetrate from the outer surface of the first connection end 1110 to the inner surface. At the same time, an elastic component 1114 and a limit slot 1115 are also set on the outer surface of the first connection end 1110. The limit slot 1115 is an annular groove, set in the circumferential direction of the first connection end 1110.

In this embodiment, the elastic component 1114 is a spiral spring, which is spirally wound around the outer surface of the first connection end 1110, and a part of the spiral spring is installed and fixed in the limit slot 1115.

In some embodiments (not shown), the elastic component 1114 can also be a steel plate spring, or a torsion bar spring, or a gas spring, or a rubber spring, or other components with elasticity.

Further, each round hole 1111 is embedded with a corresponding card receiving ball 1112, which is spherical in shape and used to reinforce the connection relationship of parts. In some embodiments (not shown), the shape of the card receiving ball 1112 can also be rectangular, or square, or elliptical, or any other three-dimensional geometric shape, curved and irregular shape.

Further, there are multiple card slots 1113 set along the circumferential direction on the inner surface of the first connection end 1110, and the card slots 1113 are evenly distributed on the inner surface of the first connection end 1110.

Refer to FIG. 3, in this embodiment, the second connection end 1120 is a cylindrical structure, one end of the second connection end 1120 has a chamfer structure 1140, and the angle of chamfering is 30° to 60°. Using a rounded structure can make the graphic attributes softer and more comfortable, giving a sense of safety and intimacy. Secondly, rounded corners are easier for human eyes to recognize than right angles, and compared with right-angle structures, rounded corners are safer and less likely to cause bumps or bruises.

Further, the interior of the first connection block 1100 is a hollow structure, and the first connection end 1110 and the second connection end 1120 are interconnected.

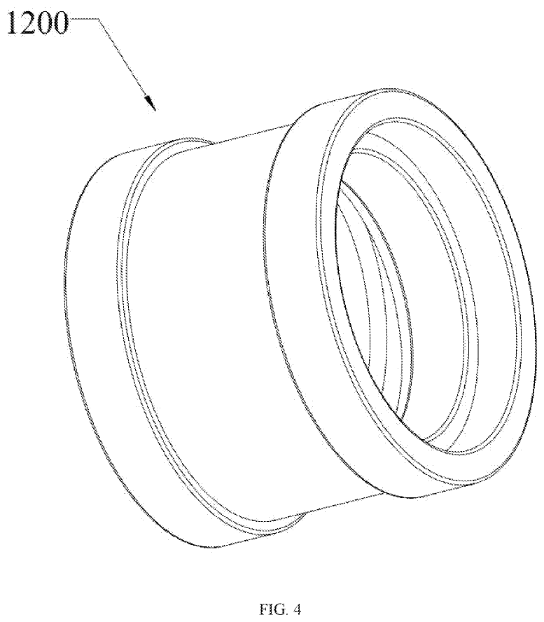

Refer to FIG. 4, the second connection block 1200 is a tubular body with a hollow interior. Both ends of the second connection block 1200 are symmetrical, and the overall shape is an axisymmetric structure.

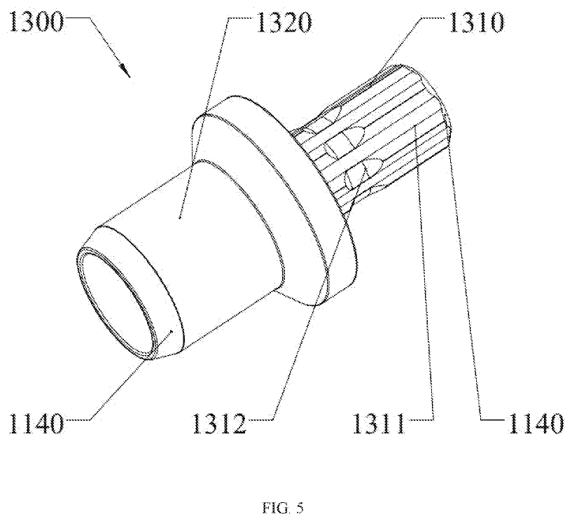

Refer to FIG. 5, the third connection block 1300 is composed of a plug-in part 1310 and a third connection end 1320. The interior of the plug-in part 1310 is a solid structure, and the exterior has a cylindrical outer surface. A chamfer structure 1140 is set on the plug-in part 1310, and the chamfer angle is 30° to 60°. The shape of the chamfer structure 1140 on the plug-in part 1310 is wavy.

Further, multiple cards block 1311 and multiple grooves 1312 are set on the outer surface of the plug-in part 1310, and the card blocks 1311 and grooves 1312 are evenly arranged along the circumferential direction of the plug-in part 1310. The groove 1312 is located in the middle part of the card block 1311, dividing the card block 1311 into two small parts.

Refer to FIG. 5, the third connection end 1320 is a cylindrical structure with a hollow interior. One end of the third connection end 1320 has a chamfer structure 1140, and the chamfer angle is 30° to 60°.

Refer to FIG. 1, in this embodiment, the connector 1000 formed by the first connection block 1100, second connection block 1200, and third connection block 1300 has an irregular cylindrical shape. The first connection block 1100, second connection block 1200, and third connection block 1300 all have a maximum outer contour, and the diameters of their maximum outer contours are equal. The first connection block 1100, second connection block 1200, and third connection block 1300 are coaxially assembled during assembly, and all three are made of metal material. In some embodiments, the shape of the connector can also be rectangular, or square, or elliptical, or any other geometric shape, curved and irregular shape, and materials can also be carbon steel, or plastic, or alloy steel or other rigid materials.

Refer to FIG. 1, specifically, during the connection process, one end of the second connection block 1200 is sleeved around the outer circumference of the first connection block 1100, and the first connection end 1110 is fixed inside one end of the second connection block 1200. The other end of the second connection block 1200 is sleeved around the outer circumference of the third connection block 1300, and the plug-in part 1310 passes through the second connection block 1200, inserts and fixes inside the first connection block 1100.

Further, in this embodiment, the card block 1311 is fixed on the card slot 1113 by a card connection method to form a detachable connection. The card receiving ball 1112 is fixed in the groove 1312 by a card connection method to form a detachable connection, thereby further strengthening the fixation of the connector.

Card connection is a relatively economical, effective, simple and convenient connection method. It can be directly formed on parts, and no other locking parts such as screws and nuts are needed during assembly, saving costs. At the same time, the connection strength of card connection can meet most product designs, in some products that require higher connection strength. And, due to its simplicity and convenience, through reasonable design, card connection can achieve quick assembly and disassembly, and even no auxiliary tools are needed for disassembly and assembly. In addition, card connection is also a kind of connection method that can maintain good integrity of product appearance, thereby improving visual effects.

It should be further explained that the connection method is not limited to the above-mentioned connection methods. Those skilled in the art can flexibly adjust and set up connection methods in actual applications, such as Velcro connection methods, or glue bonding methods, or zipper connection methods, or buckle connection methods. Or threaded connections and other remaining fixed connections, as long as they can normally connect parts.

As a preferred embodiment of the invention, the invention provides a cleaning hose 2000. The cleaning hose 2000 is connected by a connector 1000.

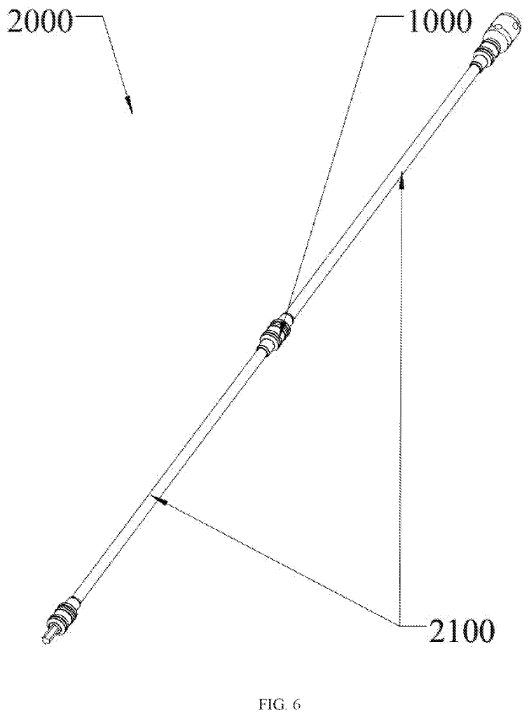

Refer to FIG. 6, the cleaning hose 2000 includes a connector 1000 and a hose component 2100.

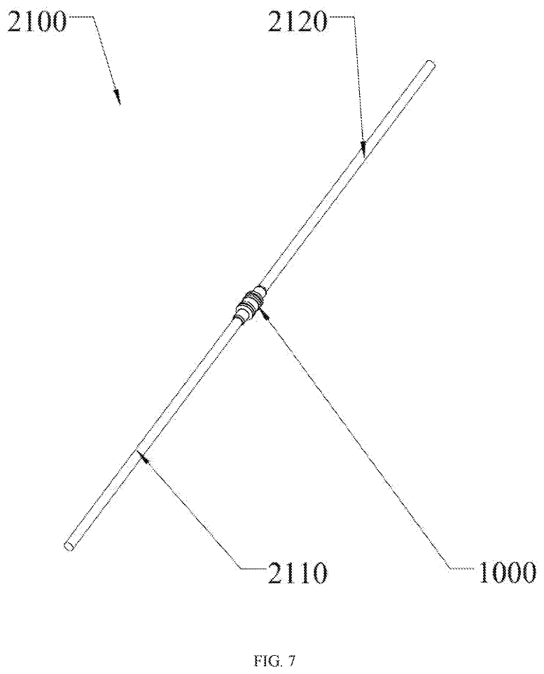

Refer to FIG. 7, the hose component 2100 is composed of a first hose 2110 and a second hose 2120, the structure and shape of the first hose 2110 and the second hose 2120 are basically the same, both of them have a solid interior and a cylindrical exterior.

In this embodiment, the first hose 2110 and the second hose 2120 are made of plastic material. The plastic material has strong corrosion resistance, does not react with acid or alkali, and has high durability. It is waterproof, lightweight, easy to be shaped into different shapes and has low manufacturing cost. At the same time, it is also a good insulator. In some embodiments (not shown), the material of the hose can also be soft steel, or wood, or other flexible materials.

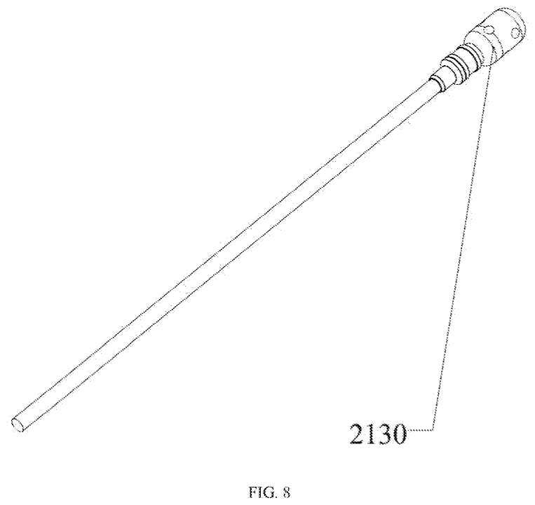

Further, refer to FIG. 8, one of the first hose 2110 and second hose 2120 is equipped with a cleaning head 2130, which is connected to one of the hoses through the connector 1000.

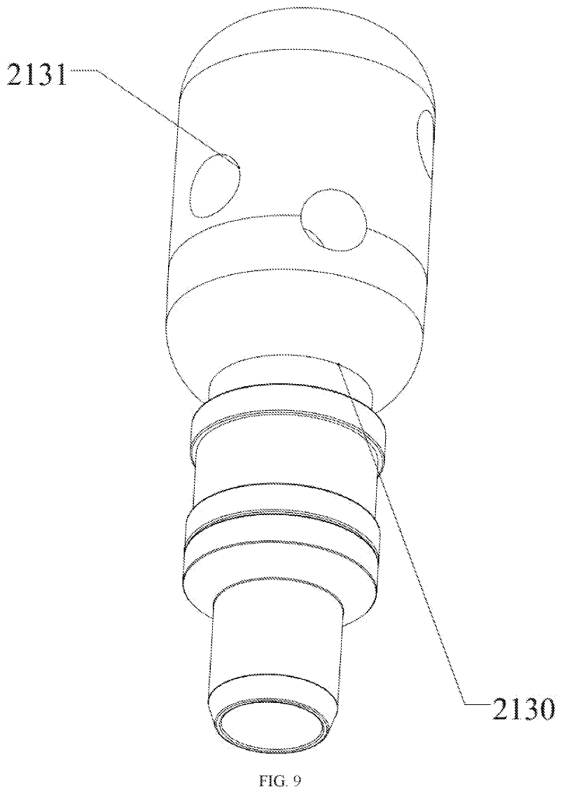

Refer to FIG. 9, multiple through holes 2131 are set on the top of the cleaning head 2130, the through holes 2131 penetrate through the cleaning head 2130, allowing the cleaning tool to be fixed on the cleaning head 2130 by passing through the through holes 2131.

In this embodiment, the material of the cleaning head 2130 is made of plastic. In some embodiments (not shown), the material of the hose can also be soft steel, or wood, or other flexible materials.

Specifically, refer to FIG. 6, since the cylindrical diameters of the first hose 2110 and the second hose 2120 are respectively equal to the second connection end 1120 and the third connection end 1320, during the connection process, one end of the first hose 2110 is fixed inside the second connection end 1120 of the first connection block 1100, and one end of the second hose 2120 is fixed inside the third connection end 1320 of the third connection block 1300.

In this embodiment, as a preferred embodiment of the invention, the invention provides a method, which is a method for assembling and using the cleaning hose 2000.

Specifically, when the cleaning hose 2000 needs to be assembled, firstly, one end of the second connection block 1200 is sleeved around the outer circumference of the first connection block 1100. Since a spring is set on the outer surface of the first connection block 1100, the second connection block 1200 can be movably sleeved around the outer circumference of the first connection block 1100, thus forming a detachable connection with the first connection block 1100. The other end of the second connection block 1200 is then sleeved around the outer circumference of the third connection block 1300, and the plug-in part 1310 passes through the second connection block 1200, and forms a detachable connection with the first connection block 1100 through card block 1311 and card slot 1113. The card receiving ball 1112 cooperates with groove 1312, further strengthening the connection relationship, making the connection of connector more stable and not easy to loosen, thus completing assembly of connector 1000.

Secondly, after assembly of connector 1000 is completed, since cylindrical diameters of first hose 2110 and second hose 2120 are respectively equal to second connection end 1120 and third connection end 1320. One end of first hose 2110 is inserted into interior of second connection end 1120 in first connection block 1100 and fixed there. One end of second hose 2120 is also inserted into interior of third connection end 1320 in third connection block 1300 and fixed there. Afterwards, another connector 1000 is assembled at other end of one hose, cleaning head 2130 is fixed at other end of hose through connector 1000. Thus, completing assembly of cleaning hose 2000.

When using the cleaning hose 2000, you only need to fix the cleaning tool on the through hole 2131 of the cleaning head 2130 for use. Extend the cleaning hose 2000 to the dirty area, and rotate the cleaning hose 2000 manually by the user to rotate the cleaning tool, thereby achieving a cleaning effect.

Since the cleaning head 2130 and the cleaning tool are detachably connected, during use, you can replace the cleaning tool in time to ensure cleanliness. If it is inconvenient to use due to the excessive length of the hose component 2100, you can use only one hose or two shorter hoses for assembly and use. If you encounter a place where the cleaning hose 2000 cannot reach, you can extend the overall length of the cleaning hose 2000 by adding multiple connectors 1000 and hose components 2100. This makes the cleaning hose 2000 suitable for scenes of different heights.

In this embodiment, the cleaning hose 2000 applied in this invention is mainly used for cleaning soot in chimneys. In some embodiments, the cleaning hose 2000 can also be used for cleaning windows, or walls, or other places that need cleaning in daily contact.

In some embodiments (not shown), connectors can be used in the construction industry, they can be used to connect support structures to ensure the stability of buildings; in some embodiments (not shown), connectors can be used in the mechanical industry, they can be used to connect mechanical arms or other types of rods, to ensure the accuracy and reliability of mechanical movement; in other embodiments, connectors can also be used in the transportation industry, they can be used for some parts of vehicles, improving vehicle safety and stability.

In some embodiments (not shown), this connector can also be used in products such as furniture, sports equipment, tents, etc. For example: in the furniture industry, it can be used to connect the support structures of tables, chairs or cabinets to improve the stability and durability of the furniture. In the sports equipment industry, it can be used to connect the support structures of fitness equipment to ensure the safety of athletes. In the tent industry, it can be used to connect the support rods of tents to improve the stability and wind resistance of tents.

In summary, this invention application, through its unique design structure, allows multiple hoses to be connected through the connector, and after multiple hoses are connected, they are not easy to rotate relative to each other, and the connection of multiple hoses can be applied to various occasions. At the same time, this invention application also provides a cleaning hose using this connector and its assembly and use method, making the installation of the cleaning hose convenient, simple and fast, thereby further enhancing the user experience, providing better visual effects and improving work efficiency.

The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Similarly, the use of “based at least in part on” is meant to be open and inclusive, in that a process, step, calculation, or other action “based at least in part on” one or more recited conditions or values may, in practice, be based on additional conditions or values beyond those recited. Headings, lists, and numbering included herein are for ease of explanation only and are not meant to be limiting.

The various features and processes described above may be used independently of one another, or may be combined in various ways. All possible combinations and sub-combinations are intended to fall within the scope of the present disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed examples. Similarly, the example systems and components described herein may be configured differently than described. For example, elements may be added to, removed from, or rearranged compared to the disclosed examples.

The invention has now been described in detail for the purposes of clarity and understanding. However, those skilled in the art will appreciate that certain changes and modifications may be practiced within the scope of the appended claims.

Conditional language used herein, such as, among others, “can,” “could,” “might,” “may,” “e.g.,” and the like, unless specifically stated otherwise, or otherwise understood within the context as used, is generally intended to convey that certain examples include, while other examples do not include, certain features, elements, and/or steps. Thus, such conditional language is not generally intended to imply that features, elements and/or steps are in any way required for one or more examples or that one or more examples necessarily include logic for deciding, with or without author input or prompting, whether these features, elements and/or steps are included or are to be performed in any particular example.

What is claimed is:

1. A connector, comprising:
a first connection block, a second connection block, and a third connection block, wherein
said first connection block is composed of a first connection end and a second connection end, said first connection end has a cylindrical surface, and multiple round holes are evenly arranged around said first connection end, said round holes are embedded with card receiving balls, said first connecting end has an inner surface and an inner surface, the inner surface of said first connection end is evenly arranged with multiple card slots, an elastic component is also set on the outer surface of said first connection end; and
said third connection block includes a plug-in part and a third connection end, said plug-in part has a cylindrical surface, and its outer surface is evenly arranged with multiple cards blocks and multiple grooves; and
said second connection block is movably sleeved on the outer circumference of said first connection block through said elastic component, the plug-in part of said third connection block is inserted and fixed inside said first connection block, said card blocks are fixed on said card slots, and said card receiving balls are fixed in cooperation with said grooves.

2. The connector according to claim 1, wherein
the inside of said first connection block is a hollow structure, and said first connection end is connected to said second connection end.

3. The connector according to claim 2, wherein
there is a limit slot on the outer surface of said first connection end, and said limit slot is arranged in a circumferential direction on said first connection end.

4. The connector according to claim 3, wherein
said elastic component is a spiral spring, said spiral spring is wound on the outer surface of said first connection end, and at least a part of said spiral spring is fixed in said limit slot.

5. The connector according to claim 4, wherein
said second connection block is a symmetrically arranged tubular body with a hollow structure inside.

6. The connector according to claim 5, wherein
a chamfer structure is set on said plug-in part, and said chamfer structure is wave-shaped, with a chamfer angle of 30° to 60°.

7. The connector according to claim 6, wherein
said plug-in part has a solid cylindrical structure, and said third connection end is a hollow cylindrical structure.

8. The connector according to claim 7, wherein
said groove is set in the middle of said card block, dividing said card block into two parts.

9. The connector according to claim 8, wherein
said second connection end and said third connection end are equipped with a chamfer structure, which has a chamfer angle of 30° to 60°.

10. The connector according to claim 9, wherein
said first connection block, said second connection block, and said third connection block all have a maximum outer contour, and the diameters of said maximum outer contour are equal.

11. The connector according to claim 10, wherein
said first connection block, said second connection block, and said third connection block material are rigid materials.

12. The connector according to claim 11, wherein
said card block is detachably connected to said card slot by a card connection method, and said card receiving ball is detachably connected to said groove by a card connection method.

13. A cleaning hose, comprising:
a connector and a hose component, wherein
said connector includes a first connection block, a second connection block, and a third connection block, where said first connection block is composed of a first connection end and a second connection end, where said first connection end has a cylindrical surface, and multiple round holes are evenly arranged around said first connection end, and said round holes are embedded with a card receiving ball, and multiple card slots are evenly arranged on the inner surface of said first connection end, where an elastic component is also set on the outer surface of said first connection end, said third connection block includes a plug-in part and a third connection end, where said plug-in part has a cylindrical surface, and multiple card blocks and multiple grooves are evenly arranged on the outer surface of said plug-in part, where said second connection block is movably sleeved on the outer circumference of said first connection block through said elastic component, and the plug-in part of said third connection block is inserted and fixed inside said first connection block, and said card block is fixed on said card slot, and said card receiving ball is fixed in cooperation with said groove; and
said hose component consists of a first hose and a second hose; and
where one end of said first hose is fixed in the second connection end of said first connection block, and one end of said second hose is fixed in the third connection end of said third connection block.

14. The cleaning hose according to claim 13, wherein
said hose component has a cleaning head attached to the other end of at least one hose, and said cleaning head is fixed on said hose through said connector.

15. The cleaning hose according to claim 14, wherein
there are multiple through holes on said cleaning head, and a cleaning tool is set on said through holes.

16. The cleaning hose according to claim 15, wherein
both said first hose and said second hose are cylindrical in shape with a solid structure inside, made of flexible material.

17. The cleaning hose according to claim 16, wherein
the diameters of said first hose and said second hose are respectively equal to those of said second connection end and said third connection end.

18. A method of using a cleaning hose, comprising:
a connector and a hose component, wherein
said connector includes a first connection block, a second connection block, and a third connection block, where said first connection block is composed of a first connection end and a second connection end, and said third connection block includes a plug-in part and a third connection end; and
said hose component is composed of a first hose and a second hose, and at least one end of one hose in said hose component is equipped with a cleaning head, which has multiple through holes; and
wherein, when said cleaning hose needs to be assembled for use,
said second connection block is sleeved on the outside of said first connection block, said third connection block is connected and fixed to the first connection end of said first connection block through said plug-in part, and said second connection block is located between said first connection block and said third connection block, thus completing the assembly of said connector; and
one end of said first hose is fixed in said second connection end, and one end of said second hose is fixed in the third connection end of said third connection block, thus completing the assembly of said cleaning hose; and
the cleaning head of said hose component is assembled on one hose, and a cleaning tool is connected and fixed on said cleaning head, thus enabling cleaning.

19. The method of using the cleaning hose according to claim 18, wherein
said cleaning head and said cleaning tool are detachably connected, and said cleaning tool is fixed in said through hole by a penetration method.

20. The method of using the cleaning hose according to claim 19, wherein
said cleaning hose can be lengthened by assembling multiple said connectors and multiple said hose components.
